(19) United States
(12) Patent Application Publication
(10) Pub. No.: US 2020/0188963 A1
(43) Pub. Date: Jun. 18, 2020

(54) Quick cleaning apparatus for large display screen

(71) Applicant: Mengjie Ye, Dongguan City (CN)

(72) Inventor: Mengjie Ye, Dongguan City (CN)

(21) Appl. No.: 16/796,913

(22) Filed: Feb. 20, 2020

(30) Foreign Application Priority Data
Oct. 11, 2019 (CN) 201910963627X

(51) Int. Cl. B08B 1/04; B08B 1/00; B08B 3/04

(52) U.S. Cl. CPC B08B 1/04; B08B 3/04; B08B 1/002

(57) ABSTRACT

The invention discloses a large-scale quick-cleaning device for a display screen, which includes a storage box fixed on a truck, and an upper end surface of the storage box is provided with a lifting cavity with an upward opening, and the lifting cavity is provided with a lifting device for lifting. The device comprises a first motor fixedly arranged at the center of the lower wall of the lifting cavity, and a lifting platform can be slid up and down above the first motor, and a support block is fixedly arranged on the rear side of the upper end surface of the lifting platform. The upper end surface is provided with a turning groove, and a turning plate is rotatably provided between the left and right walls of the turning groove.

### CROSS-REFERENCES TO RELATED APPLICATIONS

The present application claims priority from Chinese application No. 201910963627X filed on Oct. 11, 2019 which is hereby incorporated by reference in its entirety.

### TECHNICAL FIELD

The present invention relates to the technical field of display screen cleaning, in particular to a quick cleaning apparatus for large display screen.

### BACKGROUND OF THE INVENTION

Due to the growing demand for advertising, more and more large outdoor LED displays have appeared. Dynamic advertising is used to achieve better publicity effects. Due to the high cost of the display and its exposure to the street, it is extremely vulnerable to dust, etc. To accelerate the aging of the display screen, it is necessary to clean and maintain the display screen from time to time in order to reduce equipment investment. The current cleaning of outdoor display screens mainly relies on the hand of a cleaner to hang the hand tools in the air for manual cleaning operations. The cleaning liquid not only has a slow cleaning speed, but also has a greater safety hazard for the personal safety of the cleaning worker. The invention illustrates a device capable of solving the above problems.

### BRIEF SUMMARY OF THE INVENTION

### Technical Problem

Large display screens are easily exposed to dust on the street, which accelerates the aging of the display screens. The current cleaning of outdoor display screens mainly relies on manual cleaning of workers by hanging hand-held tools in the air. Even cleaning fluids are often added during cleaning. Not only is the cleaning speed slow, but the personal safety of the cleaners has a large potential safety hazard.

In order to solve the above problem, this example designs a large-screen quick-cleaning device. The large-screen quick-cleaning device of this example includes a storage box fixed on a truck, and an upper end of the storage box is provided with an opening upward. The lifting chamber is provided with a lifting device. The lifting device includes a first motor fixedly disposed at the center of the lower wall of the lifting chamber. The first motor provides power for raising and lowering the lifting platform. A support block is fixed behind the upper end surface of the lifting platform. A turning groove is provided on the upper end surface of the supporting block. There is a flip plate, and a screen cleaning device is provided on the rear end surface of the flip plate. The screen cleaning device includes a slideway provided on the rear end surface of the flip plate and opening backward. The slideway is rotatable between left and right walls. A second screw is provided, and a second motor is fixed in the right wall of the slideway and on the right side of the second screw, and the second screw is dynamically connected to the second motor and the second screw is With threaded connection A second threaded barrel extending to the outside, a transport device is provided on the left side of the storage box, and the transport device includes a liquid storage tank fixed on the truck and on the left side of the storage box, and the liquid storage box is provided inside A liquid storage chamber is provided, and a water pump is fixed on the lower wall of the liquid storage chamber. The upper end face of the liquid storage tank is symmetrically provided with fixed blocks forward and backward, and a winding is provided between the fixed blocks on the front and back sides to be rotatable. A winding rod, and a feeding tube connected to the water pump is wound on the winding rod, and the winding rod is used for winding up the feeding tube of an excess length.

Wherein, the lifting device includes a connecting groove provided on the lower end surface of the lifting platform and opening downward, the front and rear walls of the connecting groove are symmetrical on the left and right sides, and slide grooves are connected to each other. The left and right ends of the first motor are symmetrically and dynamically connected. A first screw, a first screw barrel is threadedly connected to the first screw, a first connection block is fixed on the upper end surface of the first screw barrel, and a hinge is provided between the lifting platform and the first motor The first and left ends of the hinge telescopic rod that are rotatably connected to the same side of the first connecting block, and the left and right ends of the upper side of the hinge telescopic rod extend into the connecting groove and are fixedly provided with slides A rod, the front and rear ends of the sliding rod extending into the sliding groove on the same side.

Preferably, a support block is fixed at the upper end of the front surface of the flip plate, a second connection block is fixed at the front surface of the flip plate and below the support block, and a third is fixed at the front side of the upper end surface of the lifting platform. A connecting block, a hydraulic arm is rotatably provided on a front end surface of the third connecting block, and the other end of the hydraulic arm is rotatably connected to the second connecting block.

Wherein, the screen cleaning device includes a mounting block fixedly arranged on the rear end surface of the second threaded cylinder, and a blower cavity is provided through the left and right sides of the rear end face of the hook block, and a blower cavity is provided in front of the side wall of the blower cavity. A dust filter is fixed on the side, a motor support rod is fixed between the upper and lower walls of the dust filter, a third motor is fixed on the rear end surface of the motor support rod, and a fan is connected to the rear end of the third motor.

Preferably, two rear brush roller chambers are provided on the rear end surface of the hook block and to the right of the air supply chamber, and roller shafts are rotatably provided between the upper and lower walls of the brush roller chamber. The front end surface of the block is provided with a gear cavity forwardly opened below the brush roller cavity. The lower end of the roller shaft extends into the gear cavity and a first gear is fixedly installed. The lower wall of the first gear is rotatable. A second gear having a rear end meshed with the first gear, the front end of the second gear extending outward, and a rear end surface of the flip plate and a front side of the second gear fixedly provided with meshing with the second gear Rack of the second gear.

Wherein, the conveying device includes a spray head fixedly arranged in the upper wall of the brush roller cavity on the left side, the other end of the feeding tube communicates with the upper end of the spray head, and the rear end of the winding rod extends to the rear side. A winding wheel is fixed on the rear side of the fixing block, and a pulling wire is wound on the winding wheel. The other end of the pulling wire is fixedly connected to the left end of the lifting platform. A torsion spring is fixedly connected between the rear end faces of the fixing blocks.

The beneficial effect of the present invention is that the present invention can prevent cleaning workers from hanging in the air to perform cleaning operations, significantly reducing the risk of cleaning workers' operations, and greatly speeding up the cleaning of display screens and reducing labor. Intensity, which improves the efficiency and quality of the operation, and does not need to increase the cleaning liquid frequently, and can automatically adjust the length of the feeding tube according to the lifting height.

### BRIEF DESCRIPTION OF THE DRAWINGS

For ease of explanation, the present invention is described in detail by the following specific embodiments and the accompanying drawings.

FIG. 1 is a schematic diagram of the overall structure of a large-screen display quick cleaning device according to the present invention;

FIG. 2 is a cross-sectional view taken along the “A-A” direction of FIG. 1;

FIG. 3 is a cross-sectional view taken along the “B-B” direction of FIG. 1;

FIG. 4 is a sectional view taken along the “C-C” direction in FIG. 3.

### DETAILED DESCRIPTION OF THE INVENTION

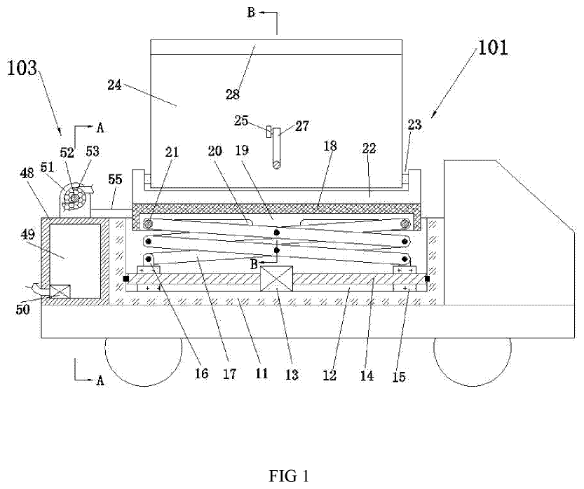

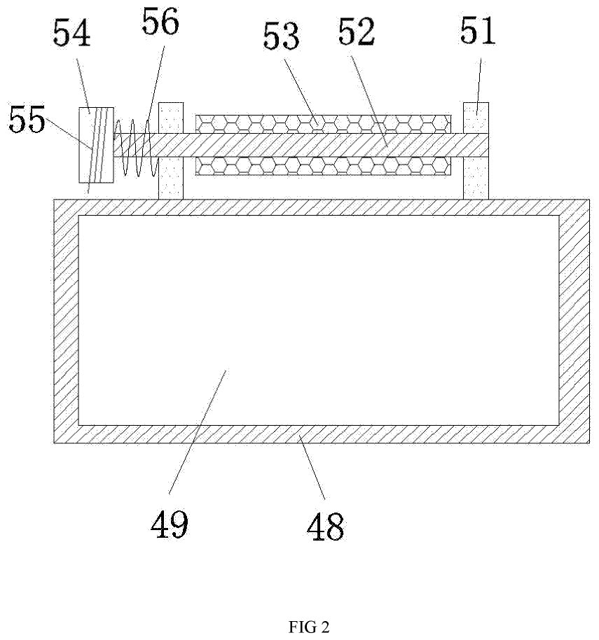

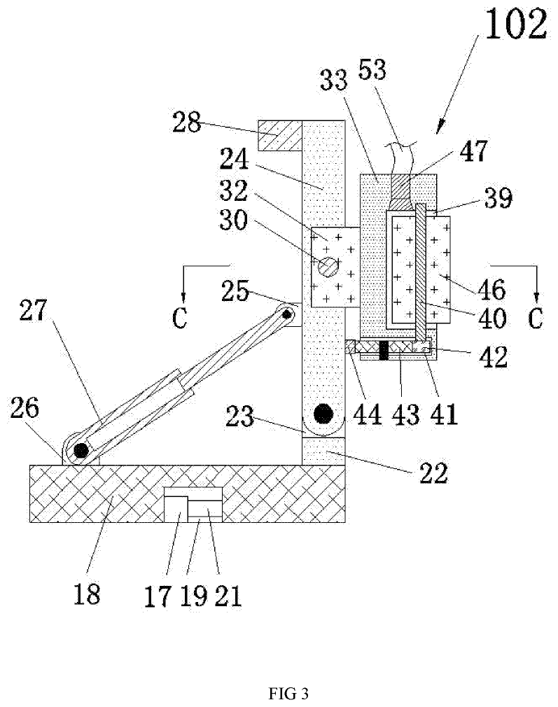

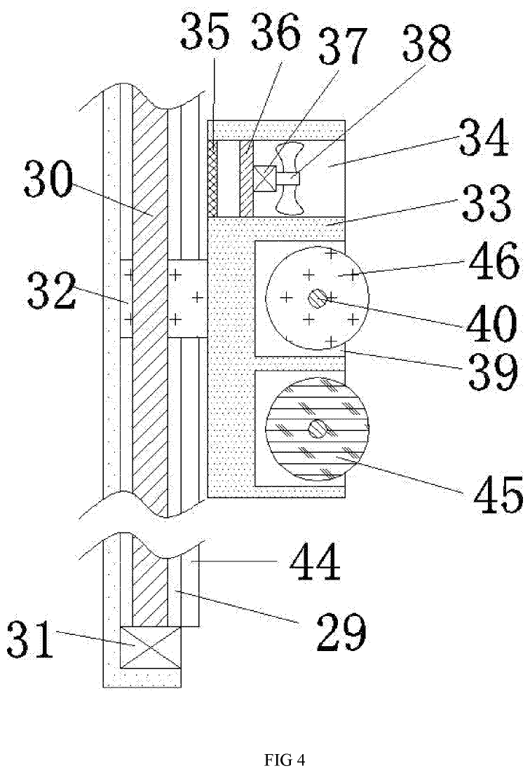

The present invention will be described in detail below with reference to FIGS. 1-4. For convenience of description, the orientation described below is defined as follows: the up-down, left-right, and front-back directions described below are consistent with the up-down, left-right, and front-back directions of the projection relationship of FIG.

The invention relates to a fast cleaning device for a large display screen, which is mainly used for cleaning large outdoor LED display screens. The present invention will be further described below with reference to the accompanying drawings of the present invention:

The rapid cleaning device for a large display screen according to the present invention comprises a storage box 11 fixedly arranged on a truck, and an upper end surface of the storage box 11 is provided with a lifting chamber 12 with an opening upward, and the lifting chamber 12 is provided with lifting Device 101, the lifting device 101 includes a first motor 13 fixedly located at the center of the lower wall of the lifting cavity 12, and a lifting platform 18 is provided above the first motor 13 so as to slide up and down. The first motor 13 is The lifting platform 18 provides power for lifting. A support block 22 is fixed on the rear side of the upper end surface of the lifting platform 18. A turning groove 23 is provided on the upper end surface of the supporting block 22. The turning groove 23 is rotatable between left and right walls. A flip plate 24 is provided. A rear end surface of the flip plate 24 is provided with a screen cleaning device 102. The screen cleaning device 102 includes a slideway 29 provided on the rear end surface of the flip plate 24 and opening backward. The slideway 29 A second screw 30 is rotatably provided between the left and right walls, and a second motor 31 is fixed in the right wall of the slideway 29 and on the right side of the second screw 30. The second screw 30 is dynamically connected. On the second motor 31, a rear end extension is screwed to the second screw 30 The second threaded cylinder 32 to the outside is provided with a conveying device 103 on the left side of the storage box 11. The conveying device 103 includes a liquid storage tank 48 fixed on a truck and on the left side of the storage box 11. The liquid storage tank 48 is provided with a liquid storage cavity 49, and the lower wall of the liquid storage cavity 49 is fixed with a water pump 50. The upper end surface of the liquid storage tank 48 is symmetrical front and rear and fixed with a fixing block 51. A winding rod 52 is rotatably provided between the fixing blocks 51, and a feeding tube 53 connected to the water pump 50 is wound around the winding rod 52. The feeding tube 53 is wound up.

According to the embodiment, the lifting device 101 is described in detail below. The lifting device 101 includes a connecting groove 19 provided on the lower end surface of the lifting platform 18 and opening downwards. In the chute 20, a first screw 14 is symmetrically and dynamically connected to the left and right ends of the first motor 13, and a first screw cylinder 15 is screw-connected to the first screw 14. The upper end surface of the first screw cylinder 15 is fixedly provided. A first connection block 16, a hinge telescopic rod 17 is provided between the lifting platform 18 and the first motor 13, and the left and right ends of the hinge telescopic rod 17 are rotatably connected to the first side of the same side The connecting block 16, the left and right ends of the upper side of the hinge telescopic rod 17 extend into the connecting groove 19 and are fixedly provided with slide bars 21, and the front and rear ends of the slide bar 21 extend to the slide groove 20 on the same side. Inside.

Beneficially, a support block 28 is fixed at the upper end of the front surface of the flip plate 24, a second connection block 25 is fixed at the front surface of the flip plate 24 and below the support block 28, and the front side of the upper end surface of the lifting platform 18 A third connecting block 26 is fixedly provided. A front end surface of the third connecting block 26 is rotatably provided with a hydraulic arm 27. The other end of the hydraulic arm 27 is rotatably connected to the second connecting block 25.

According to an embodiment, the screen cleaning device 102 is described in detail below. The screen cleaning device 102 includes a mounting block 33 fixedly disposed on the rear end surface of the second threaded cylinder 32, and the front and rear sides of the rear end surface of the mounting block 33 are left and right. A blower cavity 34 is provided therethrough, and a dust filter 35 is fixed on the front side of the side wall of the blower cavity 34. A motor support rod 36 is fixed between the upper and lower walls of the dust filter 35, and the motor support rod 36 is fixed. A third motor 37 is fixed on the rear end surface, and a fan 38 is dynamically connected to the rear end of the third motor 37.

Beneficially, there are two brush roller cavities 39 on the rear end surface of the hooking block 33 and on the right side of the air supply cavity 34, and roller shafts 40 are rotatably provided between the upper and lower walls of the brush roller cavity 39. The front end surface of the hooking block 33 is provided with a gear cavity 41 opening forward under the brush roller cavity 39. The lower end of the roller shaft 40 extends into the gear cavity 41 and a first gear 42 is fixedly provided. The lower wall of the first gear 42 is rotatably provided with a second gear 43 whose rear end is meshed with the first gear 42. The front end of the second gear 43 extends to the outside. A rack 44 meshed with the second gear 43 is fixed on a front side of the second gear 43.

According to the embodiment, the conveying device 103 will be described in detail below. The conveying device 103 includes a nozzle 47 fixed in the upper wall of the brush roller cavity 39 on the left side, and the other end of the feeding pipe 53 communicates with the At the upper end of the nozzle 47, the rear end of the winding rod 52 is extended to the rear side of the fixing block 51 at the rear side and a winding wheel 54 is fixedly fixed thereon, and a winding wire 55 is wound around the winding wheel 54. The other end is fixedly connected to the left end of the lifting platform 18, and a torsion spring 56 is fixedly connected between the front end surface of the reel 54 and the rear end surface of the adjacent fixing block 51.

The following describes in detail the use steps of a large-screen quick-cleaning device in this article with reference to FIGS. 1 to 4:

At the beginning, the first threaded cylinder 15 is at a limit position away from the first motor 13, the hinge telescopic rod 17 is in a retracted state, the lifting platform 18 is in a lower limit position, the hydraulic arm 27 is in a contracted state, and the support block 28 and the upper end of the lifting platform 18 In contrast, the turning plate 24 is in a horizontal state, and the second screw cylinder 32 and the hooking block 33 are in a left limit position.

When working, the truck is parked in front of the screen, the first motor 13 is started to drive the first screw 14 to rotate, and the first threaded cylinder 15 is slid to the side close to the first motor 13 by thread engagement, and the hinge telescopic rod 17 is extended to drive the lifting platform. 18 rises, at the same time, the hydraulic arm 27 stretches and drives the flip plate 24 to flip to the vertical state. The rear ends of the dust brush 45 and the cleaning brush 46 abut against the display screen. When the lifting platform 18 rises, the pull wire 55 pulls the reel 54 to rotate. The reel 54 is rotated to loosen and open the feeding pipe 53, the water pump 50 is activated to send the special cleaning liquid in the liquid storage chamber 49 to the spray head 47, the spray head 47 sprays the cleaning liquid onto the surface of the cleaning brush 46, and the second motor 31 is started to drive the second screw 30 turns, drives the second threaded cylinder 32 to slide to the right through the screw connection, the mounting block 33 slides right with the second threaded cylinder 32, the second gear 43 moves relative to the rack 44, and the second gear 43 rotates and passes The gear meshing drives the roller shaft 40 to rotate, the right roller shaft 40 drives the dust removal brush 45 to rotate to remove dust on the display surface, and the left roller shaft 40 drives the cleaning brush 46 sprayed with cleaning liquid to scrub the display surface. Motor 3 7 Start to drive the fan 38 to rotate. The fan 38 sends air to dry the cleaned display surface. After cleaning one line, the hydraulic arm 27 contracts to drive the flip plate 24 to flip forward until the dust brush 45 and cleaning brush 46 come out of contact with the display. The second motor 31 reverses and drives the second threaded cylinder 32 and the connecting block 33 to return to the left limit position. The first motor 13 starts and drives the lifting platform 18 to lift and lower the display screen for cleaning in another row. When the cleaning is completed, the lifting platform When 18 is lowered to the lower limit position, the reel 54 turns and tightens and winds the pull wire 55 under the action of the torsion spring 56. At the same time, the winding rod 52 rotates with the reel 54 and winds the feeding tube containing excess length. 53.

The beneficial effect of the present invention is that the present invention can prevent cleaning workers from hanging in the air to perform cleaning operations, significantly reducing the risk of cleaning workers' operations, and greatly speeding up the cleaning of display screens and reducing labor. Intensity, which improves the efficiency and quality of the operation, and does not need to increase the cleaning liquid frequently, and can automatically adjust the length of the feeding tube according to the lifting height.

In the above manner, those skilled in the art can make various changes according to the working mode within the scope of the present invention.

1. A large-scale quick-cleaning apparatus for a display screen includes a storage box fixedly arranged on a truck, an upper end surface of the storage box is provided with a lifting chamber with an opening upward, and the lifting chamber is provided with a lifting device. The lifting device includes a fixed A first motor is provided at the center of the lower wall of the lifting chamber, and a lifting platform can be slid up and down above the first motor. The first motor provides power for lifting of the lifting platform. A support block is fixed on the side, a turning groove is provided on the upper end surface of the supporting block, and a turning plate is rotatably provided between the left and right walls of the turning groove; a screen cleaning apparatus is provided on the rear end surface of the flip plate, and the screen cleaning device includes a slideway provided on the rear end surface of the flip plate and opening rearward, and a second portion is rotatably provided between the left and right walls of the slideway. A screw, a second motor is fixedly located in the right wall of the slideway and to the right of the second screw, the second screw is dynamically connected to the second motor, and the second screw is screwed to the rear A second threaded barrel whose end extends to the outside; a conveying device is provided on the left side of the storage box, and the conveying device includes a liquid storage box fixed on the truck and on the left side of the storage box. The liquid storage box is provided with a liquid storage chamber, and the liquid storage A water pump is fixed on the lower wall of the cavity, and the upper end surface of the liquid storage tank is symmetrical and fixed with fixing blocks. A winding rod is rotatably provided between the fixing blocks on the front and back sides, and the winding rod is rolled up. A feeding tube that is connected to the water pump is wound, and the winding rod is used to wind the feeding tube of an excess length.

2. The rapid cleaning device for a large display screen according to claim 1, wherein the lifting device comprises a connecting groove provided on the lower end surface of the lifting platform and opening downward, and the front and rear walls of the connecting groove are symmetrical left and right and A chute is connected to the first motor, and a first screw is symmetrically and dynamically connected to the left and right ends of the first motor. A first screw cylinder is screw-connected to the first screw, and a first connection is fixed on an upper end surface of the first screw cylinder. Piece; a hinge telescopic rod is provided between the lifting platform and the first motor, and the left and right ends of the lower side of the hinge telescopic rod are rotatably connected to the first connection block on the same side, and the upper side of the hinge telescopic rod Both left and right ends of the sliding rod extend into the connecting slot and are fixedly provided with sliding rods, and the front and rear ends of the sliding rod extend into the sliding slot on the same side.

3. The rapid cleaning device for a large display screen according to claim 1, characterized in that: a support block is fixed at the upper end of the front surface of the flip plate; a second connection block is fixed at the front end surface of the flip board and below the support block, a third connection block is fixed at the front side of the upper end surface of the lifting platform, and the front end surface of the third connection block is rotatably provided with hydraulic pressure. The other end of the hydraulic arm is rotatably connected to the second connecting block.

4. The rapid cleaning device for a large display screen according to claim 1, wherein the screen cleaning device comprises a mounting block fixedly disposed on a rear end surface of the second threaded cylinder, and the rear end surface of the mounting block is left A blower cavity is provided through the front and rear sides, and a dust filter is fixed on the front side of the side wall of the blower cavity. A motor support rod is fixed between the upper and lower walls of the dust filter. The rear end surface of the motor support rod is fixed. There is a third motor, and a fan is connected to the rear end of the third motor.

5. The rapid cleaning device for a large display screen according to claim 4, characterized in that: two rear brush roller chambers are provided on the rear end surface of the mounting block and on the right side of the air supply chamber, A roller is rotatably provided between the upper and lower walls; the front end surface of the hook block is provided with a gear cavity forwardly opened below the brush roller cavity. The lower end of the roller shaft extends into the gear cavity and a first gear is fixedly provided. The second wall is rotatably provided with a second gear whose rear end is meshed with the first gear, and the front end of the second gear extends to the outside; a rack on the rear end surface of the turning plate and a front side of the second gear is fixedly engaged with the second gear.

6. The rapid cleaning device for a large display screen according to claim 1, wherein the conveying device comprises a spray head fixedly arranged in the upper wall of the brush roller cavity on the left side, and the other end of the feeding tube is in communication At the upper end of the nozzle; a rear end of the winding rod extends to the rear side of the fixed block and a reel is fixedly arranged thereon. A winding wire is wound around the reel, and the other end of the pulling wire is fixedly connected to the lifting platform, torsion spring is fixedly connected between the front end surface of the reel and the rear end surface of the adjacent fixed block.
